(19) United States
(12) Patent Application Publication
(10) Pub. No.: US 2005/0110812 A1
(43) Pub. Date: May 26, 2005

(54) Plasma display panel and driver providing gray scale representation

(76) Inventors: Seung-Ho Park, Suwon-si (KR); Joon-Koo Kim, Suwon-si (KR); Jong-Doo Park, Suwon-si (KR); Yong-Seok Chi, Suwon-si (KR); Myoung-Kwan Kim, Suwon-si (KR); Jae-Seok Jeong, Suwon-si (KR)

Correspondence Address: CHRISTIE, PARKER & HALE, LLP, PO BOX 7068, PASADENA, CA, 91109-7068, US

(21) Appl. No.: 10/990,144

(22) Filed: Nov. 15, 2004

(30) Foreign Application Priority Data
Nov. 26, 2003 (KR) 10-2003-0084554

(51) Int. Cl. G09G 5/02

(52) U.S. Cl. 345/693

(57) ABSTRACT

A plasma display panel (PDP) driver and PDP gray scale representation method for applying a sustain pulse based subfield arrangement and address light for representation of gray scales and improving representation performance of gray scales. Inverse gamma correction is performed on input image signals so as to represent inverse gamma correction gray scales corresponding to a number of sustain pulses and address light. The inverse gamma correction gray scale is inverted into a subfield based on the number of sustain pulses so as to represent the gray scale through address light and light caused by the number of sustain pulses.

### CROSS REFERENCE TO RELATED APPLICATION

This application claims priority to and the benefit of Korea Patent Application No. 10-2003-0084554 filed on Nov. 26, 2003 with the Korean Intellectual Property Office, the entire content of which is incorporated herein by reference.

### BACKGROUND OF THE INVENTION

(a) Field of the Invention

The present invention relates to a plasma display panel (PDP) driver and a PDP gray scale representation method, and more particularly, a PDP driver and a PDP gray scale representation method for improving gray scale representation performance.

(b) Description of the Related Art

Recently, flat panel displays, such as liquid crystal displays (LCDs), field emission displays (FEDs), and PDPs, have been actively developed. The PDPs are becoming preferred over the other flat panel displays with regard to their high luminance, high luminous efficiency, and wide viewing angle. Accordingly, the PDPs are being highlighted as a substitute for conventional cathode ray tubes (CRTs) for large-screen displays of more than 40 inches.

The PDPs are flat panel displays that use plasma generated by gas discharge to display characters or images. The PDPs include, according to their size, more than several tens to millions of pixels arranged in the form of a matrix. These PDPs are classified into a direct current (DC) type and an alternating current (AC) type according to patterns of waveforms of driving voltages applied thereto and discharge cell structures thereof.

The DC PDP has electrodes exposed to a discharge space, thereby causing current to directly flow through the discharge space during application of a voltage to the DC PDP. In this connection, the DC PDP has a disadvantage in that it requires a resistor for limiting the current. On the other hand, the AC PDP has electrodes covered with a dielectric layer that naturally forms a capacitance component to limit the current and protects the electrodes from the impact of ions during discharge. As a result, the AC PDP is considered superior to the DC PDP with regard to a long lifetime.

FIG. 1 is a perspective view illustrating a part of an AC PDP. Scan electrodes 4 and sustain electrodes 5 covered with dielectric layer 2 and protective layer 3 are arranged in pairs in parallel on first glass substrate 1. A plurality of address electrodes 8 covered with insulation layer 7 are arranged on second glass substrate 6. Barrier ribs 9 are formed in parallel with address electrodes 8 on insulation layer 7 such that each barrier rib 9 is interposed between adjacent address electrodes 8. Phosphor 10 is coated on the surface of insulation layer 7 and on both sides of each partition wall 9. First and second glass substrates 1, 6 are arranged to face each other while defining discharge space 11 therebetween so that address electrodes 8 are orthogonal to scan electrodes 4 and sustain electrodes 5. In the discharge space, discharge cell 12 is formed at an intersection between each address electrode 8 and each pair of scan electrodes 4 and sustain electrodes 5.

FIG. 2 shows an arrangement of the electrodes in the PDP of FIG. 1. The electrodes of the PDP are arranged in the form of an m×n matrix. m address electrodes A1 to Am are arranged in a column direction. n scan electrodes Y1 to Yn and n sustain electrodes X1 to Xn are alternately arranged in a row direction. Discharge cell 12 shown in FIG. 2 corresponds to discharge cell 12 shown in FIG. 1.

In general, a process for driving the AC PDP can be expressed by temporal operation periods, i.e., a reset period, an address period, and a sustain period. The reset period is a period wherein the state of each cell is initialized such that an addressing operation of each cell is smoothly performed. The address period is a period wherein an address voltage is applied to an (addressed) cell to accumulate wall charges on the addressed cell to in order to select a cell to be turned on and a cell not to be turned on in the PDP. The sustain period is a period wherein sustain pulses are applied to the addressed cell, thereby performing a discharge according to which a picture is actually displayed.

As shown in FIG. 3, in the PDP, a gray scale is expressed by dividing one frame (1 TV frame) into a plurality of sub-fields and performing a time-division operation for the plurality of sub-fields. Each sub-field includes the reset period, the address period, and the sustain period. FIG. 3 illustrates one frame divided into 8 sub-fields in order to express 256 levels of gray scale. Each sub-field SF1-SF8 includes reset periods (not shown), address periods Ad1-Ad8, and sustain periods S1-S8. Sustain periods S1-S8 have emission periods 1T, 2T, 4T, . . . , 128T of the ratio of 1:2:4:8:16:32:64:128.

For example, a level 3 of gray scale is expressed by discharging a discharge cell during a sub-field having an emission period of 1T and a sub-field having an emission period of 3T so as to have a total emission period of 3T. In this way, a combination of different sub-fields having different emission periods produces pictures of 256 levels of gray scales.

Also, as to the conventional PDP gray scale representation, the number of pulses allocated for each subfield is determined by multiplying a subfield weight which corresponds to a sustain period according to a per-frame mean gray scale. That is, the number of sustain pulses is differentiated depending on the per-frame mean gray scale in order to increase contrast for each frame and reduce power consumption. For example, a multiple of four of the subfield weight is used in order to allocate a relatively high number of sustain pulses in the case of a low mean gray scale, and pulses of a multiple of two of the subfield weight are used in order to allocate a relatively low number of sustain pulses in the case of a high mean gray scale, to thereby represent 256 levels of gray scales. Therefore, the conventional method is restricted in increasing representation performance of gray scales since the gray scales are represented by multiplying the subfield weight determined according to the gray scale by a predetermined multiple irrespective of the number of sustain pulses and increasing the total of sustain pulses. Further, the conventional method has a large unit of light in representing the gray scales since it uses the light emitted by the number of sustain pulses in a sustain period, thereby restricting low gray scale representation.

### SUMMARY OF THE INVENTION

In accordance with the present invention a PDP driver and a PDP gray scale representation method are provided for improving representation performance of gray scales by representing the gray scales by as many as the number of sustain pulses, and by applying address light to gray scale representation.

In one aspect of the present invention, a PDP driver for dividing an image of each field displayed on the PDP in correspondence to an input image signal into a plurality of subfields, representing gray scales according to combinations of the subfields, and displaying an image corresponding to the image signal, includes an inverse gamma corrector, a sustain pulse subfield converter, and a scan and sustain driver. The inverse gamma corrector performs inverse gamma correction on the input image signal so as to represent an inverse gamma correction gray scale corresponding to a number of sustain pulses and address light. The sustain pulse subfield converter converts the inverse gamma correction gray scale output by the inverse gamma corrector into a subfield based on a number of sustain pulses so as to represent the gray scale through light caused by address light and the number of sustain pulses. The scan and sustain driver applies a number of sustain pulses for each subfield corresponding to a control signals generated based on the subfield arrangement converted by the sustain pulse subfield converter to the PDP.

In another aspect of the present invention, in a gray scale representation method for a PDP for dividing an image of each field displayed on the PDP in correspondence to an input image signal into a plurality of subfields, representing gray scales according to combinations of the subfields, and displaying an image corresponding to the image signal, (a) inverse gamma correction is performed on the input image signal so as to represent an inverse gamma correction gray scale corresponding to a number of sustain pulses and address light, (b) an inverse gamma correction gray scale output in (a) is converted into a subfield on the basis of the number of sustain pulses so as to represent gray scales through address light and the number of sustain pulses, and (c) an image which corresponds to subfield data generated in (b) is controlled to be displayed on the PDP.

In still another aspect of the present invention, a PDP includes: a plasma panel, a driver, and a controller. The plasma panel includes first and second electrodes formed in parallel on a first substrate, and third electrodes formed to cross the first and second electrodes on a second substrate. The driver applies a sustain pulse used for driving the first and second electrodes. The controller applies a control signal to the driver, the control signal dividing a frame into a plurality of subfields and controlling a number of subfields which configure the frame and a number of sustain pulses allocated to respective subfields. In this instance, the controller includes an inverse gamma corrector for performing inverse gamma correction on the input image signal so as to represent an inverse gamma correction gray scale corresponding to a number of sustain pulses and address light, and a sustain pulse subfield converter for converting the inverse gamma correction gray scale output by the inverse gamma corrector into a subfield based on a number of sustain pulses so as to represent the gray scale through light caused by address light and the number of sustain pulses.

### BRIEF DESCRIPTION OF THE DRAWINGS

FIG. 1 shows a partial perspective view of an AC PDP.

FIG. 2 shows a PDP electrode arrangement diagram.

FIG. 3 shows a PDP gray scale representation method.

FIG. 4 shows a block diagram of a PDP according to an exemplary embodiment of the present invention.

FIG. 5 shows a block diagram of a PDP controller according to an exemplary embodiment of the present invention.

FIG. 6 shows a graph of an exemplified inverse gamma correction by an inverse gamma corrector according to an exemplary embodiment of the present invention.

FIG. 7 shows a table for a subfield arrangement with respect to numbers of sustain pulses in a sustain pulse subfield converter of a controller according to an exemplary embodiment of the present invention.

FIG. 8 shows a light emission pattern table for representing respective gray scales in a subfield arrangement with respect to numbers of sustain pulses for using address light.

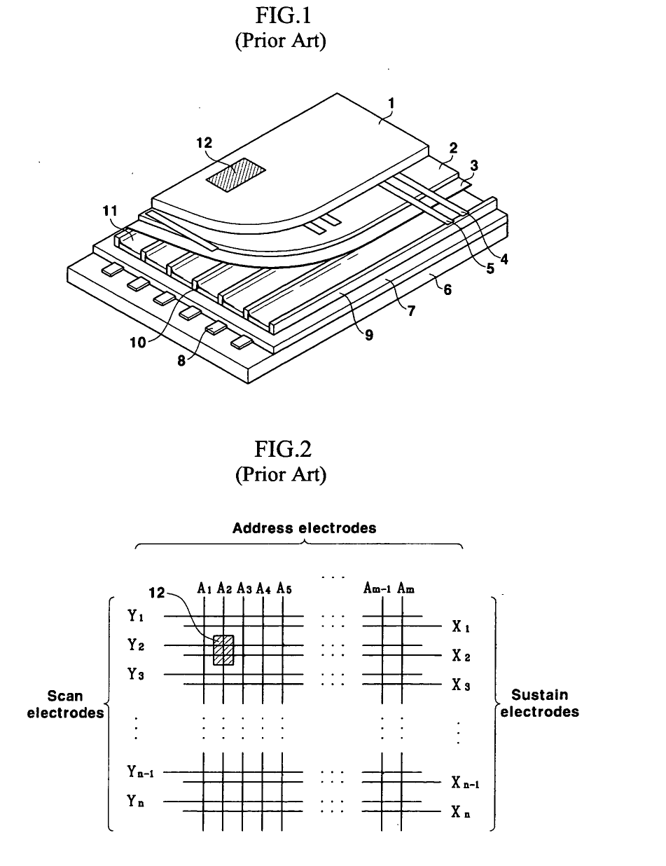

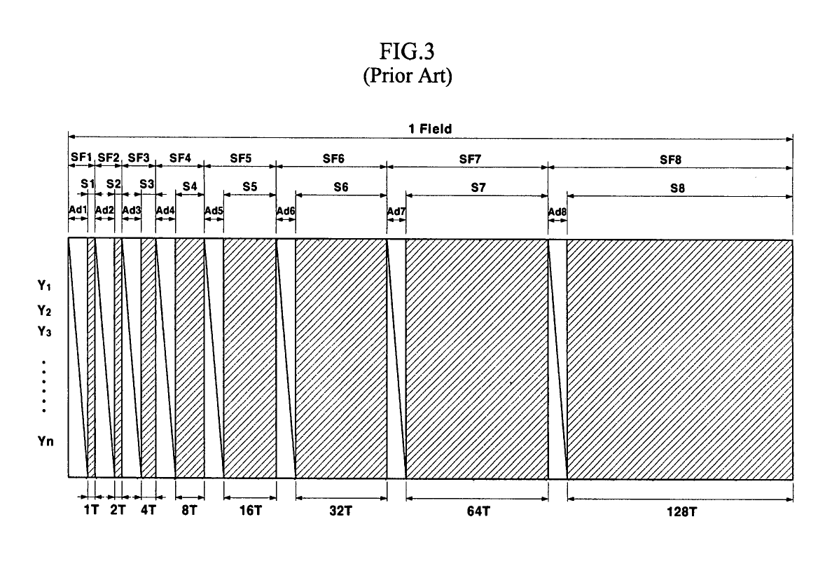

### DETAILED DESCRIPTION

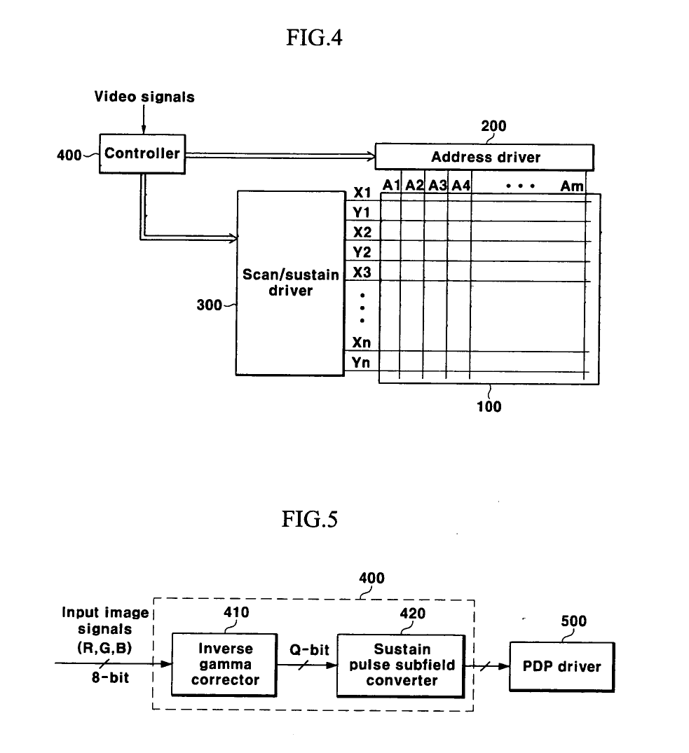

Referring now to FIG. 4, a PDP according to an exemplary embodiment of the present invention includes plasma panel 100, address driver 200, scan and sustain driver 300, and controller 400.

Plasma panel 100 includes a plurality of address electrodes A1 to Am arranged in a column direction, and a plurality of scan electrodes Y1 to Yn and a plurality of sustain electrodes X1 to Xn alternately arranged in a row direction. Address driver 200 receives an address driving control signal from controller 400, and applies display data signals to respective address electrodes A1 to Am for selecting desired discharge cells. Scan and sustain driver 300 receives a control signal from controller 400, and alternately applies sustain pulse voltages to scan electrodes Y1 to Yn and sustain electrodes X1 to Xn, respectively, thereby causing selected discharge cells to perform a sustain discharge.

Controller 400 externally receives video signals, such as a red, green, blue (RGB) image signal and a synchronization signal, divides one frame of the RGB image signal into a plurality of sub-fields, and divides each sub-field into a reset period, an address period, and a sustain period for driving the PDP. Controller 400 then supplies address driver 200 and scan and sustain driver 300 with a required control signal by adjusting the number of sustain pulses to be applied during each sustain period of each sub-field within one frame.

Controller 400 according to an exemplary embodiment of the present invention will be described in more detail with reference to FIGS. 5 to 8. Controller 400 includes inverse gamma corrector 410 and sustain pulse subfield converter 420.

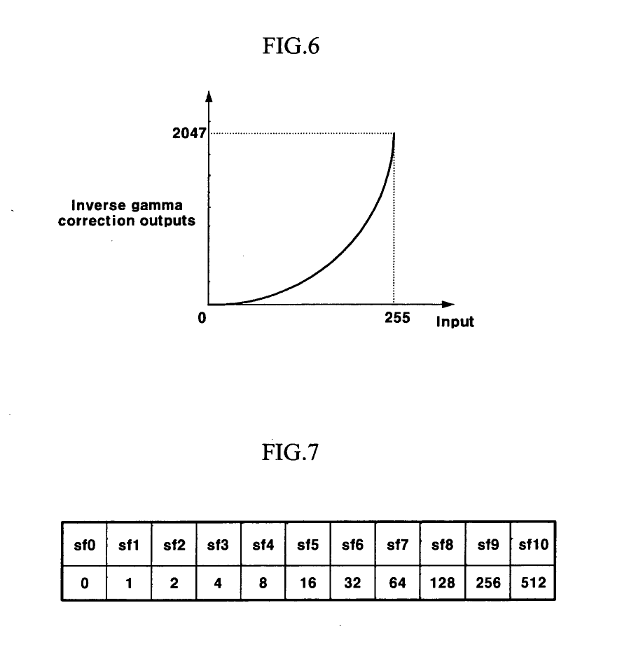

Inverse gamma corrector 410 maps n-bit input image signals to an inverse gamma curve to correct them to Q-bit image signals. Since the conventional input image signals are 8-bit signals, the case of 8-bit input image signals will be described. When correcting the 8-bit gray scales of the input image signals to Q-bit gray scales, inverse gamma corrector 410 determines outputs of inverse gamma correction according to a predetermined number of sustain pulses. The Q bits output by inverse gamma corrector 410 are determined by Equation 1.
2^{Q-1}≦2P<2^{Q} Equation 1
where P is a number of sustain pulses.
   For example, when the number of sustain pulses is given as 1,023, the output data have eleven bits according to Equation 1, and a lookup table of inverse gamma corrector 410 is determined as shown in FIG. 6. That is, inverse gamma corrector 410 represents an inverse gamma correction gray scale corresponding to the number of sustain pulses. In this instance, a ‘2P’ is used without using the general ‘P’ in Equation 1 because the subfields that emit address light are used to represent gray scales instead of representing the gray scales through the number of sustain pulses. Therefore, inverse gamma corrector 410 represents an inverse gamma correction gray scale corresponding to the number of sustain pulses and the address light (which indicates light emitted by the subfield which has an address period).

In this instance, the image signals input to inverse gamma corrector 410 are digital signals, and analog signals need to be converted into digital signals by using an analog-to-digital converter (not illustrated) when the analog image signals are input to the PDP. Inverse gamma corrector 410 may include a lookup table (not illustrated) for storing data corresponding to the inverse gamma curve for mapping the image signals, and a logic circuit (not illustrated) for generating data corresponding to the inverse gamma curve through logic operations.

Referring back to FIG. 5, sustain pulse subfield converter 420 converts the number of sustain pulses output by inverse gamma corrector 410 and the inverse gamma correction gray scale corresponding to the address light into subfield data based on the number of sustain pulses. That is, the subfields have been converted on the basis of the number of sustain pulses in the prior art, but they are converted on the basis of the number of sustain pulses according to the exemplary embodiment of the present invention. For example, the sustain pulse subfield arrangement shown in FIG. 7 can be used when the number of sustain pulses is 1,023, the number of subfields is 11, and the address light emitted by the subfield with the address period is used for representation of gray scales.

FIG. 7 shows a table for a subfield arrangement with respect to numbers of sustain pulses in sustain pulse subfield converter 420 of a controller according to an exemplary embodiment of the present invention. In other words, FIG. 7 shows the table for the numbers of sustain pulses of the respective subfields when the number of sustain pulses is 1,023, the number of subfields is 11, and the address light is used for representation of gray scales. As shown, the respective subfields sf0 to sf10 do not have weights but have numbers of sustain pulses. In this instance, the address light is used and no sustain light caused by the number of sustain pulses is used when representing the minimum gray scale of 1. The sf0 indicates a subfield which has no sustain pulses and performs addressing. That is, when representing the minimum gray scale of 1, an addressing operation is generated, and the gray scale of 2 is represented by one sustain pulse. In this instance, the address light is used since the address operation is performed in the subfield of sf1, and the subfield for performing the address operation is not used for representing the gray scale of 2. The subfield for performing the address operation is added, and the subfield at which the address light is emitted is used for representing the gray scales. The address period has functioned to generate a weak discharge and accumulate wall charges in order to select desired cells on PDP 100, and the weak discharge is now used in the exemplary embodiment as a light for representing gray scales, through which representation performance of low gray scales is further improved.

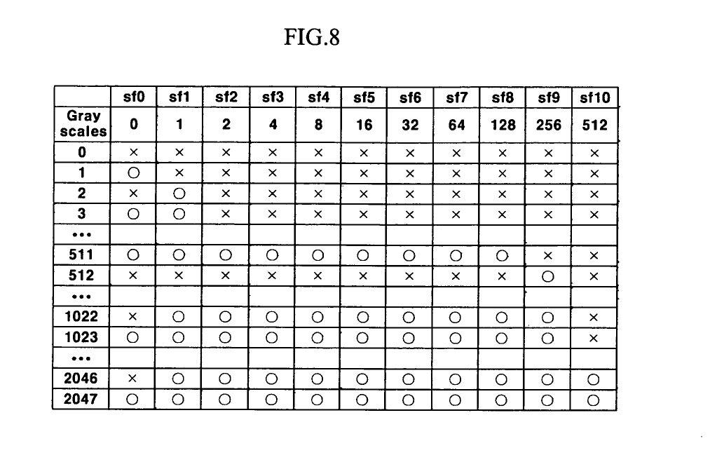

FIG. 8 shows a light emission pattern table for representing respective gray scales in a subfield arrangement with respect to numbers of sustain pulses for using the address light. As shown, the subfield of sf0 for performing the address operation is used to generate address light in order to represent the gray scale of 1, and the subfield of sf1 with one sustain pulse emits light to represent the gray scale of 2. Also, the gray scale of 3 is represented when the address light (in the subfield of sf0) and the sustain light (with one sustain pulse in the subfield of sf1) are summed through the subfield of sf0 for performing the address operation and the subfield of sf1 having one sustain pulse. In like manner, as shown in FIG. 8, a total of 2,048 gray scales are represented by the subfield arrangements on the basis of numbers of sustain pulses when the number of subfields is 11, the number of sustain pulses is 1,023, and the subfield for performing the address operation is used. That is, 2,048 gray scales are represented as shown in FIG. 8 when using 1,023 sustain pulses since the light caused by using the subfield of sf0 which performs the address operation is less than the light caused by one sustain pulse.

Therefore, the representation performance of gray scales is doubled and is maximized without additional calculation by adding the subfield arrangement based on the number of sustain pulses by the controller and the subfield which uses the address light. That is, the representation performance of gray scales is maximized by determining the sustain pulse subfield arrangement according to the number of sustain pulses (randomly determined) which are maximally used without additional calculation such as an error diffusion method. Also, the representation performance of gray scales is improved by adding the subfield which uses address light and reducing a predetermined amount of light.

The number of sustain pulses of the respective subfields shown in FIGS. 7 and 8 can be modified to some degree when representing the gray scales on the basis of the number of sustain pulses, which would be understood by a person skilled in the art. For example, the subfield of sf3 can have three sustain pulses, and the number of sustain pulses can be changed for other subfields.

As seen in FIG. 5, the subfield data (sustain pulse number data) of the subfield arrangement based on the number of sustain pulses converted by sustain pulse subfield converter 420 are transmitted to PDP driver 500, that is, address driver 200 and scan and sustain driver 300, and are displayed on PDP 100. In this instance, scan and sustain driver 300 applies no sustain pulse to the subfield (i.e., sf0) which has no sustain pulse used for representing the minimum gray scale, and thus represents the subfields which emit address light.

As described above, the representation performance of gray scales is doubled and is maximized without additional calculation by adding the subfield arrangement based on the number of sustain pulses and the subfields which use address light. In addition, a predetermined amount of light is reduced by adding the subfields which use address light, and hence, the representation performance of gray scales is further improved.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A plasma display panel driver that performs a reset period, an address period, and a reset period, the driver dividing an image of each field displayed on a plasma display panel in correspondence with an input image signal into a plurality of subfields, representing gray scales according to combinations of the subfields, and displaying an image corresponding to the image signal, comprising:
an inverse gamma corrector for performing inverse gamma correction on the input image signal to provide image signal data output which represent an inverse gamma correction gray scale corresponding to a number of sustain pulses and address light;
a sustain pulse subfield converter for converting the image signal data output by the inverse gamma corrector into a subfield based on a number of sustain pulses so as to represent the gray scale through light caused by address light and the number of sustain pulses; and
a scan and sustain driver for applying a number of sustain pulses for each subfield corresponding to a control signals generated based on the subfield arrangement converted by the sustain pulse subfield converter to the plasma display panel.

2. The plasma display panel driver of claim 1, wherein the sustain pulse subfield converter generates a subfield for performing an address operation so as to use address discharging light created during the address operation to represent gray scales.

3. The plasma display panel driver of claim 1, wherein the sustain pulse subfield converter converts the gray scale into a subfield corresponding to a minimum gray scale so that a subfield which has address light may be turned on.

4. The plasma display panel driver of claim 2, wherein the sustain pulse subfield converter converts the gray scale into a subfield corresponding to a minimum gray scale so that a subfield which has address light may be turned on.

5. The plasma display panel driver of claim 2, wherein the scan and sustain driver applies no sustain pulse to the subfield for performing an address operation.

6. The plasma display panel driver of claim 1, wherein bits of the image signal data output by the inverse gamma corrector are determined by a maximum number of sustain pulses applied to the plasma display panel.

7. The plasma display panel driver of claim 2, wherein bits of the image signal data output by the inverse gamma corrector are determined by a maximum number of sustain pulses applied to the plasma display panel.

8. The plasma display panel driver of claim 1, wherein the number of subfields converted by the sustain pulse subfield converter is determined by the maximum number of sustain pulses applied to the plasma display panel.

9. The plasma display panel driver of claim 2, wherein the number of subfields converted by the sustain pulse subfield converter is determined by the maximum number of sustain pulses applied to the plasma display panel.

10. The plasma display panel driver of claim 1, wherein the number of gray scales to be represented by the sustain pulse subfield converter corresponds to twice the addition of 1 and the maximum number of sustain pulses applied to the plasma display panel.

11. The plasma display panel driver of claim 2, wherein the number of gray scales to be represented by the sustain pulse subfield converter corresponds to twice the addition of 1 and the maximum number of sustain pulses applied to the plasma display panel.

12. A gray scale representation method for a plasma display panel for dividing an image of each field displayed on a plasma display panel in correspondence to an input image signal into a plurality of subfields, representing gray scales according to combinations of the subfields, and displaying an image corresponding to the image signal, comprising:
(a) performing inverse gamma correction on the input image signal to provide image signal data output which represent an inverse gamma correction gray scale corresponding to a number of sustain pulses and address light;
(b) converting the image signal data output into a subfield on the basis of the number of sustain pulses so as to represent gray scales through address light and the number of sustain pulses; and
(c) controlling an image which corresponds to subfield data generated in (b) to be displayed on the plasma display panel.

13. The gray scale representation method of claim 12, wherein a subfield converted in (b) includes a subfield which performs an address operation so as to use address discharging light created during the address operation to represent gray scales.

14. The gray scale representation method of claim 13, wherein conversion in (b) allows the subfield which performs the address operation to be turned on when representing the minimum gray scale.

15. The gray scale representation method of claim 12, wherein the number of gray scales to be represented by combinations of the subfields converted in (b) is twice the addition of 1 and the maximum number of sustain pulses applied to the plasma display panel.

16. The gray scale representation method of claim 13, wherein the number of gray scales to be represented by combinations of the subfields converted in (b) is twice the addition of 1 and the maximum number of sustain pulses applied to the plasma display panel.

17. The gray scale representation method of claim 12, wherein the number of subfields converted in (b) is determined by a maximum number of sustain pulses applied to the plasma display panel.

18. The gray scale representation method of claim 13, wherein the number of subfields converted in (b) is determined by a maximum number of sustain pulses applied to the plasma display panel.

19. A plasma display panel comprising:
a plasma panel including first electrodes and second electrodes formed in parallel on a first substrate, and third electrodes formed to cross respective first electrodes and second electrodes on a second substrate;
a driver for applying a sustain pulse used for driving the first electrodes and the second electrodes; and
a controller for applying a control signal to the driver, the control signal dividing a frame into a plurality of subfields and controlling a number of subfields which configure the frame and a number of sustain pulses allocated to respective subfields,
wherein the controller includes:
an inverse gamma corrector for performing inverse gamma correction on an input image signal to provide image signal data output which represent an inverse gamma correction gray scale corresponding to a number of sustain pulses and address light, and
a sustain pulse subfield converter for converting the image signal data output by the inverse gamma corrector into a subfield based on a number of sustain pulses so as to represent the gray scale through light caused by address light and the number of sustain pulses.

20. The plasma display panel of claim 19, wherein the sustain pulse subfield converter generates a subfield for performing an address operation so as to use address light for representation of gray scales.
